(19) United States
(12) Patent Application Publication
(10) Pub. No.: US 2012/0036467 A1
(43) Pub. Date: Feb. 9, 2012

(54) SYSTEM AND METHOD FOR PRODUCING A TOUR

(75) Inventors: ALFRED C. TOM, SAN FRANCISCO, CA (US); FRANCES H. JAMES, SUNNYVALE, CA (US); STEVEN C. TENGLER, GROSSE POINTE PARK, MI (US); THOMAS P. GRAU, DOYLESTOWN, PA (US)

(73) Assignees: GENERAL MOTORS LLC, DETROIT, MI (US); GM GLOBAL TECHNOLOGY OPERATIONS, INC., DETROIT, MI (US)

(21) Appl. No.: 12/850,956

(22) Filed: Aug. 5, 2010

(51) Int. Cl. G06F 3/048

(52) U.S. Cl. 715/772

(57) ABSTRACT

Systems and methods are provided for producing tours. The system includes, but is not limited to a data storage device that is configured to store a plurality of POI inputs and/or routes. A server is operatively coupled to the data storage device and is configured to host a website accessible via a worldwide computer network, obtain a search criterion from a user accessing the website, retrieve a subset of the POI inputs and/or routes corresponding to the search criterion from the data storage device, arrange the POI inputs and/or routes of the subset in a manner corresponding to the search criterion to form the tour, at least temporarily store the tour in an electronic file compatible with a mobile device, and electronically deliver the electronic file to the user.

### TECHNICAL FIELD

The technical field generally relates to tours, and more particularly relates to systems and method for producing tours.

### BACKGROUND

A common recreational activity is the taking of tours of scenic, historically significant or otherwise interesting locations. Frequently, people tour such locations by driving through areas of interest and stopping to explore them. Some people elect to drive themselves on these tours. One drawback to this approach is a person's inability to simultaneously read a guidebook and to operate a motor vehicle. Accordingly, persons taking this sort of do-it-yourself tour may drive right past a particular point-of-interest (hereinafter, POI) without learning anything about it. Drivers may also get lost using guidebooks, as paper maps and directions may not help them stay on the route as well as GPS-enabled turn-by-turn navigation systems.

Another option is to take a prepackaged tour where both the driving and POI information are provided by another entity. Several business entities provide such prepackaged guided tours to members of the public in exchange for a fee. These business entities typically provide transportation and a tour guide who is knowledgeable about the area that is the subject of the tour. Although such prepackaged guided tours obviate the need to simultaneously drive and read a guidebook, this approach has drawbacks as well. For example, the prepackaged tour may be expensive or may include some POIs that are not of interest to the person taking the tour.

In addition, both of these approaches have additional drawbacks. For example, the guidebook is prepared by a publisher who relies on a relatively small number of sources of information resulting in a guidebook that includes a correspondingly small number of POIs. Similarly, the prepackaged guided tour is limited by the number of POIs with which the tour guide is personally familiar. Also, some guidebook publishers may charge a fee to have a POI included in the guidebook. This can result in the omission of interesting POIs whose proprietors are unwilling to pay the fee and/or the inclusion of POIs that are less interesting, but whose proprietors are willing to pay the fee. The same can be true of prepackaged guided tours. In addition, guided tours are typically offered at specific times on specific dates without flexibility of start time, interruptions or permitting spontaneity injected by the customer at or between POIs.

### SUMMARY

Systems and methods for producing tours are disclosed herein.

In an embodiment, the system includes, but is not limited to, a data storage device that is configured to store a plurality of POI inputs and/or routes and a server that is operatively coupled to the data storage device. The server is configured to host a website accessible via a worldwide computer network, obtain a search criterion from a user accessing the website, retrieve a subset of the POI inputs and/or routes corresponding to the search criterion from the data storage device, arrange the POI inputs and/or routes of the subset in a manner corresponding to the search criterion to form the tour, at least temporarily store the tour in an electronic file that is compatible with a mobile device, and electronically deliver the electronic file to the user.

In another embodiment, the system includes, but is not limited to, a data storage device and a server that is operatively coupled to the data storage device. The server is configured to host a website accessible via a worldwide computer network, receive POI inputs and/or route information from a plurality of contributing users accessing the website, provide the POI inputs and/or route information to the data storage device for storage, obtain a search criterion from a user accessing the website, retrieve a subset of the POI inputs and/or route information corresponding to the search criterion from the data storage device, arrange the POI inputs and/or routes of the subset in a manner corresponding to the search criterion to form the tour, at least temporarily store the tour in an electronic file compatible with a mobile device, and electronically deliver the electronic file to the user.

In yet another embodiment, the method includes, but is not limited to, the steps of hosting a website accessible via a worldwide computer network, receiving POI inputs and/or routes at a server from a plurality of contributing users accessing the website, storing the POI inputs and/or routes in a data storage device, obtaining search criteria at the server from a user accessing the website, retrieving a subset of the POI inputs and/or routes corresponding to the search criteria from the data storage device, arranging the POI inputs and/or routes in the subset in a manner corresponding to the search criteria to form the tour, storing the tour in an electronic file compatible with a mobile device, and electronically delivering the electronic file to the user.

### DESCRIPTION OF THE DRAWINGS

One or more embodiments will hereinafter be described in conjunction with the following drawing figures, wherein like numerals denote like elements, and

FIG. 1 is a schematic view illustrating a system for producing tours;

FIG. 2 illustrates an exemplary Internet web page designed to receive information from a user that can be used by the system of FIG. 1 for producing a tour;

FIG. 3 illustrates an exemplary Internet web page designed to permit a user to edit a tour produced by the system of FIG. 1;

FIG. 4 illustrates an exemplary Internet web page that provides a user with information about one of the POIs included in the tour produced by the system of FIG. 1;

FIG. 5 illustrates an exemplary Internet web page designed to permit a contributing user to provide feedback regarding a POI; and

FIG. 6 is a flow diagram illustrating the steps of a method for producing a tour.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

A system and method for producing a tour is disclosed herein. The system and method take advantage of the abundant technology currently available to consumers in the form of embedded or in-dash navigation systems, and portable devices having any suitable location determining technology (e.g. Global Positioning System (hereinafter “GPS”)) including, but not limited to, cellular telephones (hereinafter “cell phones”), aftermarket navigation devices, and any other portable devices having location determining capabilities in them that permit them to determine their location on the surface of the earth. As used herein, the term “mobile device” shall refer to both embedded navigation systems and also portable devices.

The system and the method combine the availability of this technology with the existing widespread usage of the Internet by providing remotely accessible network services such as, but not limited to, an Internet accessible website which is configured to enable a user to compose a tour. As used herein, the term “user” refers to any person accessing the website, whether to compose a tour, to contribute information, or for any other purpose. To compose a tour, the user need only input a few items of information. Such information may include a destination or a geographical region to be explored, the amount of time that the user would like to spend on the tour, the types of POIs that the user would like to visit, the types of roads that the user would like to travel on and the types of scenery that the user would like to see along the way.

Once this information is provided, the website is designed to produce a tour that is customized for the user. The tour may include one or more POIs and potentially one or more prepackaged routes that correspond to the user's inputs. For example, if the user inputs only a single criterion specifying historical POIs, then the tour will include only POIs having historical significance.

Additionally, the POIs and/or routes will be arranged in a sequence that conforms with the user's expressed preferences or that otherwise makes logical sense (i.e., shortest distance, chronological history, etc. . . . ). For example, if the user expressed a desire to limit the tour to a predetermined number of miles, then the POIs and/or routes will be arranged in a sequence that keeps the total distance traveled under the predetermined number of miles. In another example, if the user has expressed a desire to travel along scenic roads, then the POIs in the tour may be arranged in a sequence that ensures that the user will travel along scenic roads, or the returned tour may include a prepackaged route that was designed specifically to travel along scenic roads.

In some embodiments of the system, when the tour includes multiple POIs or routes, the user will have an opportunity to edit the tour by selecting or deleting one or more of the suggested POIs or routes. The user may also be able to add additional POIs and/or routes to the tour. For example, the website may be configured to allow the user to browse through POIs and/or routes located proximate to the tour route and to select one or more of these for inclusion on the tour.

The user may then download the tour to their portable device or to their personal computer and then transfer the tour to their portable device. In some instances, a user may be able to download the tour directly to a telematics unit located in the user's automobile. The portable device can then be plugged into the user's automobile through an auxiliary jack, a USB port, a Bluetooth connection, or via another suitable connection and may be used to guide the user as the user drives to and through the POIs and along the routes. The portable device may play audio and/or video commentary about the POI through the vehicle's onboard systems, such as a vehicle's stereo system, its DVD entertainment system, its embedded navigation system, its telematics system, or through any other suitable system onboard the vehicle. In other embodiments, the portable device may play back such commentary to the user without the aid of any onboard audiovisual system.

The tour, once loaded onto the portable device, may be capable of interacting with the portable device's position determining capability (i.e., GPS chipset, Wi-Fi, cellular base stations, etc. . . . ) to automatically play portions of the tour relating to the geographic region that the user is presently driving through or approaching. In other embodiments, the portable device may lack position determining capability, but may nevertheless obtain current location information through a connection with another onboard position determining system to obtain position coordinates and to trigger the playback of relevant portions of the tour.

The website may further be configured to receive POI inputs and/or prepackaged routes from users. As used herein, the term “POI inputs” means any information pertaining to a POI including an identification of the POI, an electronic file containing an audio or video commentary about a POI, a textual description relating to a POI, or a rating or ranking of the POI. “Prepackaged routes” means information pertaining to a set of waypoints and turn-by-turn instructions to follow that will lead the user along one or more roads. Prepackaged routes may also contain POI inputs as described above. The POI input may also be an identification of new POIs including their titles, their GPS location information (including information on a POI's “geobound” which tells the system when to trigger POI content in a navigation device), their street address, their Internet website address, a ground-level picture, a satellite picture, and a description of such new POIs. The website may also be configured to permit users to input entire tours that they have taken, including multiple POIs and the roads that were traveled between them (hereinafter, “predefined tours”). Users who provide POI inputs or predefined tours will be referred to herein as “contributing users”. The website may permit contributing users to designate whether or not other contributing users may edit, append to, or reuse information provided about a POI by the original user, therein improving the collective knowledge past the limited knowledge of the original contributing user. The website may also be configured to allow contributing users to charge for the content they contribute. This is useful for not only professional travel organizations who may contribute their content, but also for amateur users who know an area particularly well and would like to get paid for their expertise. The website may collect revenue on behalf of these contributing users and then pay the contributing users all or a portion of the revenue. Techniques for allowing contributing users to offer paid content, collecting payment from users, and paying the contributing users are commonly understood in the industry. The use of contributing users to identify new POIs, to provide predefined tours, and to provide feedback about existing POIs will result in a continuously expanding database of POIs, POI information, and predefined tours. This method of collecting POI information is referred to as crowd sourcing. By implementing crowd sourcing, the system can tap into a far greater knowledge base than is currently available to publishers of guide books or to business entities that offer tour guide services.

Using this system, a user can access a website over the Internet, choose a geographic region to explore or a start point and an end point, input one or more categories of POI and/or other criteria, and then obtain a custom made tour of the specified geographic region that includes only those POIs that are of interest to the user. The user can then download the tour to a portable device and take the tour at a time of the user's choosing. The user may connect the portable device to an entertainment system onboard the user's vehicle and then listen to and watch commentary, reviews, descriptions and other relevant information about each POI included in the tour as the user drives to and through each POI.

A further understanding of the systems and methods for producing a tour described above may be obtained through a review of the illustrations accompanying this application together with a review of the detailed description that follows.

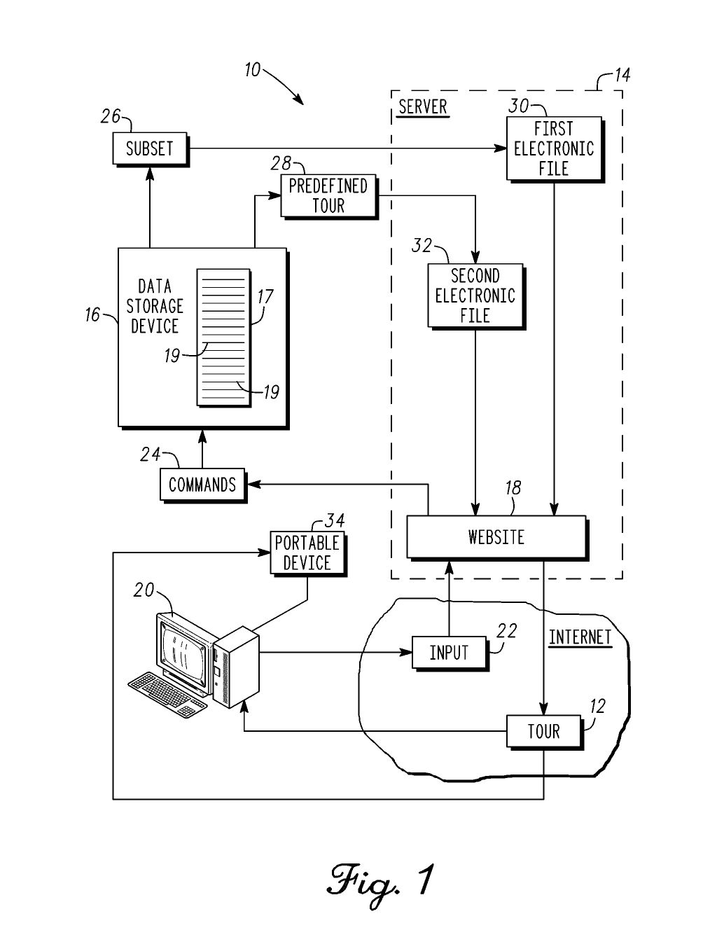

FIG. 1 is a schematic view illustrating a system 10 for producing a tour 12. System 10 includes a server 14 operatively coupled to a data storage device 16. In other embodiments, additional servers, data storage devices, or other components may also be included.

Server 14 may be any combination of hardware or software designed to provide services to clients and/or to manage resources on a computer network. Server 14 may be a personal computer that is running a server operating system or it may be a computer or computer appliance that is specially designed to enhance its ability to run software applications under the heavy demand of a network environment and that contains features making it more suitable for production environments. These features may include a faster CPU, increased high-performance RAM, redundant power supplies, and redundant network connections. In some embodiments, server 14 may be dedicated exclusively to managing data storage device 16. In such embodiments, additional components, such as a processor may also be included in system 10. In other embodiments, server 14 may be configured to both manage resources such as data storage device 16 and to also run and execute other programs. Server 14 is configured for network connectivity and can be connected to a wide variety of computer networks including Local Area Networks (“LAN”) and Wide Area Networks (“WAN”) such as the Internet.

Data storage device 16 may be any type of electronic memory device that is configured to store data. For example, data storage device 16 may include, without limitation, non-volatile memory, disk drives, tape drives, and mass storage devices and may include any suitable software, algorithms and/or sub-routines that provide the data storage component with the capability to store, organize, and permit retrieval of data. In some embodiments, data storage device 16 may comprise only a single component. In other embodiments, data storage device 16 may comprise a plurality of components acting in concert. In some embodiments, data storage device 16 may be dedicated for use exclusively with system 10 while in other embodiments, data storage device 16 may be shared with other systems. In some embodiments, data storage device 16 may be a separate or stand alone component that can be communicatively coupled with server 14 via any suitable wired or wireless connection, while in other embodiments, data storage device 16 may be a component of server 14 or otherwise integrated into server 14 and internally communicatively coupled therewith. For example, data storage device 16 and server 14 may be a single device, i.e. a server that includes storage memory and that runs database software.

Data storage device 16 is configured to store data relating to users, POIs and predefined tours. Server 14 is configured to provide commands to data storage device 16 that cause the data storage device to store the data, to organize the data, and to produce the data to server 14. The data may comprise POIs, POI inputs, predefined tours, user accounts, user names and user passwords which may be required by system 10 before granting a user access to a user account.

Server 14 is also configured to host a website 18. Website 18 is an Internet accessible website that users may access remotely via computer 20. Although computer 20 is illustrated as a desktop computer, it should be understood that computer 20 may be any suitable device capable of accessing the Internet, including, but not limited to, a mainframe computer, a desktop computer, a laptop computer, a smart phone, a personal digital assistant (“PDA”), and an Internet enabled tablet device.

Using computer 20, a user can access website 18 to upload POIs, POI inputs, and predefined tours, or to compose and download a tour. In some embodiments, the user may be required to input their name or some other identification such as an account number, a user ID and/or a password. In such embodiments, the information provided or solicited by the user can be associated with the user's account maintained by system 10 on data storage device 16. In other embodiments, a user may be able to access and utilize website 18 without providing any identification.

The user may then provide or upload one or more inputs 22 to website 18. In the case of a contributing user seeking to upload information, input 22 may include a predefined tour, a POI input, and/or a ranking of an existing predefined tour or POI input. In the case of a user seeking to compose a tour or seeking to retrieve a predefined tour, input 22 may include a criterion or multiple criteria that are needed to compose the tour. For example, input 22 may include the date or time of year when the user intends to travel, the geographic region or destination that the user would like to explore, the types of attractions that the user would like to visit, the distance that the user is willing to travel, the amount of time that the user is willing to devote to taking tour 12, the types of roads and scenery that the user would like to encounter along the way, a minimum rating received by contributing user, and any combination thereof. Server 14 can be configured to present multiple web pages on website 18, each of which can be tailored to a specific purpose and can facilitate the user's ability to upload input 22 to server 14.

Server 14 is programmed or otherwise configured to provide commands 24 to data storage device 16 to either store or retrieve data in response to receiving inputs 22 from a contributing user or a user composing a tour. For example, if input 22 comprises a POI input or a predefined tour, commands 24 will instruct data storage device 16 to store such information and to do so at a specific location. Such information may be maintained on data storage device 16 in a database 17 that can be accessed by server 14. In the illustrated embodiment, system 10 is configured to keep separate user accounts 19 for each user. The information contained in input 22 may be stored on data storage device 16 in a manner such that it is correlated with the user account associated with the contributing user.

If input 22 comprises one or more criterion input by a user composing a tour, then server 14 is configured to search the POIs and other information stored in data storage device 16 and to filter such data to derive a subset 26 of POI inputs that satisfy the criterion or criteria supplied by the user.

If input 22 comprises one or more criterion input by a user seeking to obtain a predefined tour, then server 14 is configured to search the predefined tours and other information stored in data storage device 16 and to filter such data to locate a predefined tour 28 that most closely complies with the user's inputs. In some embodiments, the results of this search may include multiple predefined tours, each substantially equally compliant with the criteria provided in input 22.

In the case of subset 26, the POI inputs may then be stored, either temporarily or permanently, on server 14 in a first electronic file 30. The POI inputs in first electronic file 30 can be arranged and revised in a manner that corresponds with input 22. For example, if subset 26 includes a large number of POI inputs, but the user has indicated that the user has only a relatively short time in which to take the tour, then server 14 may execute various algorithms and protocols to reduce the number of POI inputs in the subset by giving greater or lesser weight to one or more of the criteria included in input 22 or by randomly selecting a POI input for elimination from the subset. Server 14 may also be programmed to arrange the POI inputs in an appropriate sequence. The appropriate sequence of POI inputs in subset 26 may be based on their GPS location, their proximity to major thoroughfares, the types of roads leading to the POIs, the travel time between the POIs, and any other basis that enables tour 12 to better comply with the user's criteria. Server 14 may include a mapping program or may have access to map files stored in data storage device 16 to facilitate the sequencing of the POI inputs. In other embodiments, server 14 may remotely access or otherwise connect to mapping applications such as Google Maps to display POIs on maps and to perform route calculations using the POI inputs in subset 26. After such revising and sequencing is complete, the arrangement of POI inputs remaining in first electronic file 30 constitutes tour 12. In some embodiments, the user may be permitted to edit tour 12 by adding or deleting or rearranging the POI inputs included in tour 12.

In the case where there are multiple predefined tours 28 that satisfy the criteria included in input 22, the predefined tours 28 are each stored, either temporarily or permanently, in a second electronic file 32, or in multiple respective second electronic files 32. The number of predefined tours 28 may then be reduced to some predetermined maximum number of predefined tours specified by the user in input 22. The remaining predefined tours 28 may then be arranged in a sequence based on their compliance with the specific criteria included with input 22. After such revising and sequencing is complete, the listing of predefined tours 28 in second electronic file 32 may be presented to the user on a web page of website 18. At that time, the user may be permitted to select one or more of the predefined tours 28. Additionally, the user may be able to combine one or more of the predefined tours 28. In addition, the user can also add additional POIs to predefined tours 28 to further customize them. In some instances, the user may need to purchase content that is not offered for free. The predefined tour(s) 28 selected and/or modified by the user constitutes tour 12.

Both first electronic file 30 and the second electronic file 32 may be stored in an electronic format that is compatible with a portable device of the user's choosing. Website 18 may be configured to permit the user to select an electronic file format from among many different file formats, each compatible with a different type of portable device. Alternatively, the file formats may be in a metadata format that is generic to any device. When the user wants to download to a specific device, there may be a conversion engine that converts the generic file format to a format that is specific to the actual device. Once the user selects the appropriate format, tour 12 may be downloaded. In one embodiment, the user may choose to download tour 12 to computer 20, and then to transfer tour 12 to portable device 34. In other embodiments, if the user is accessing website 18 using portable device 34, then tour 12 may be downloaded directly to portable device 34. In yet another embodiment, the user may instruct the website to download tour 12 to a second portable device 34 separate from the device accessing the website 18. In other embodiments, the website may be configured to permit the user to electronically mail first or second electronic file 30, 32 to an email address of the user's choosing. In still other embodiments, any other method effective to deliver tour 12 to the user may be employed.

When the user takes the tour, they will select the appropriate electronic file containing the tour from their portable device's menu and execute it. Alternatively, the electronic file may be configured to automatically prompt the user to start the tour. The electronic file will be configured to command the portable device to obtain location information (such as GPS location information) from the device's GPS receiver (or other location determining equipment), or from a separate GPS receiver in another portable device or from a separate system of the vehicle. The navigation system of the device will use the information in the electronic file to produce a route that will be used to guide the user, just like a navigation application guides users to a particular destination. In fact, the route can be viewed as directions to multiple destinations one after another, each destination being either a POI or a waypoint along a route chosen by the user. In other embodiment, route guidance may be formulated on server 14 and tour 12 may consist of step-by-step driving instructions as well as POIs and waypoints. The electronic file will be configured to further control the portable device to coordinate the presentation of the POI information included in the tour with the present location of the vehicle or portable device. To accomplish this, the electronic file will include geographically synchronized commands (including audio/visual files or tagged text for activating text-to-speech engines) that will instruct the portable device to play or otherwise activate the presentation of commentary associated with the POI inputs when the portable device approaches to within a predetermined distance of the POI (the “geobound” of the POI). Accordingly, as the portable device approaches a POI, the portable device will detect its proximity to the POI and will automatically begin playback of commentary associated with that POI using either the vehicle's onboard entertainment systems, an in-dash navigation system or a speaker associated with the portable device itself.

In some embodiments, after a predetermined period of time has elapsed since the user downloaded tour 12, server 14 may be configured to follow up with the user to obtain feedback about tour 12. For example, server 14 may be configured to transmit an email to the user with a link to the website where the user can answer questions about their tour. In other embodiments, any other method of communication suitable for soliciting user feedback may be employed. In some embodiments, the tour may permit instantaneous feedback during the tour while the experience is still fresh. Non-limiting examples of feedback might be structured rating systems (e.g., 5-star, like/dislike, thumbs up/down), commentary (e.g. social networking thoughts/experiences during tour), and/or pictures taken with embedded or portable technology during the tour.

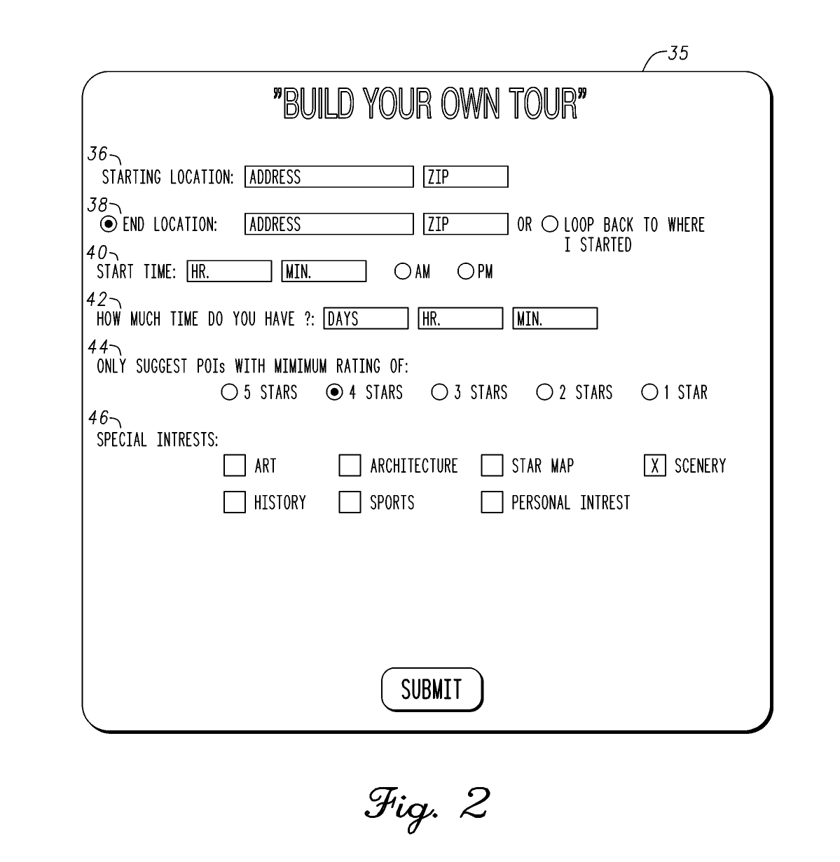

FIG. 2 illustrates an exemplary Internet web page 35 designed to receive information from a user that can be used by the system of FIG. 1 for producing a tour. In the embodiment illustrated in FIG. 2, and with continuing reference to FIG. 1, the user is asked to provide a starting address 36 and an ending address 38. In lieu of providing an ending address, the user may simply indicate a desire to return to the starting address. The use of a starting address and an ending address may be useful in situations where the user needs to travel from one location to another and would like to have an interesting drive rather than simply taking the most direct route. The situation where the user indicates an intent to end at the same address where the user began may be more appropriate for situations where the user wants to become familiar with a particular geographic region.

The user is also asked to enter the start time 40 and the amount of time 42 the user can devote to taking the tour. This information can be used by server 14 to factor in meals that will be consumed during the tour, and to choose POIs having operating hours that are compatible with the user's schedule (thus implying that in some embodiments POIs may also be defined by operating hours).

The user is also asked to specify a minimum rating 44 to be used by server 14 when selecting POIs or predefined tours from data storage device 16. Minimum rating 44 is a rating associated with each POI that has been provided by contributing users to rate a POI or a predefined tour that has been uploaded to server 14. Any suitable method of rating a POI or predefined tour may be employed.

The user is also asked to identify any special interests 46 that the user would like featured in tour 12. As indicated, the user may specify an interest in art, architecture, star maps (i.e., a tour identifying the location of celebrities), scenery, historical locations, sports themed locations and personal interests. POIs and pre-packaged tours may have such identifying tags associated with them to enable this search feature. By selecting personal interests, the user may be redirected to a new web page where the user would have an opportunity to enter any specific interest that is not expressly enumerated on web page 35.

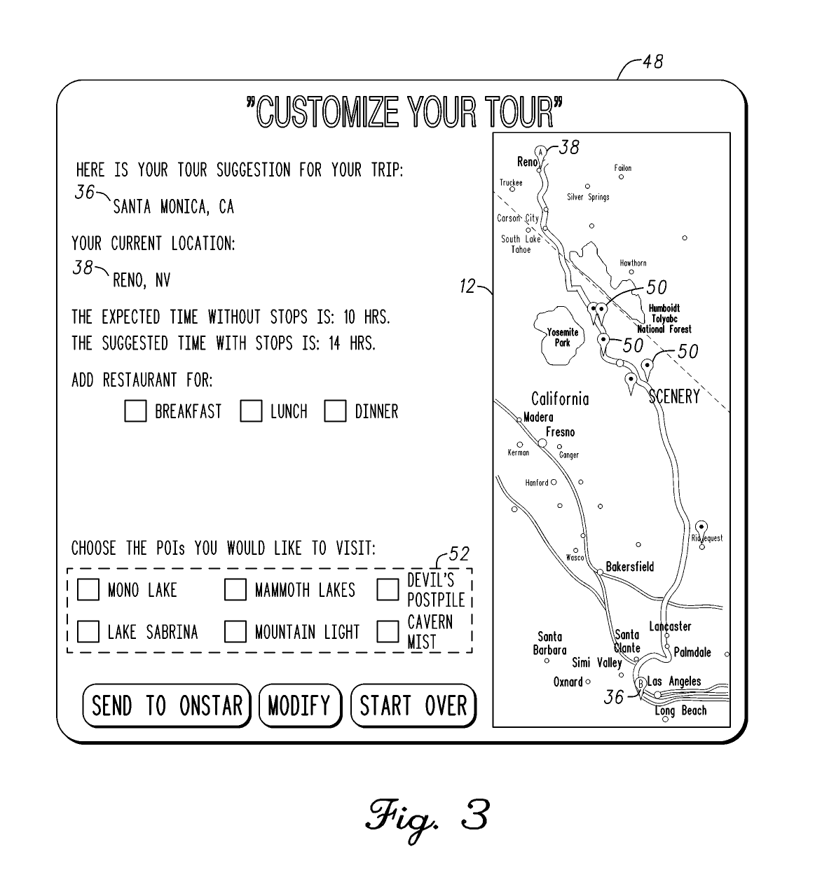

FIG. 3 illustrates an exemplary Internet web page 48 designed to permit a user to edit a tour produced by system 10 of FIG. 1. In this exemplary embodiment, and with continuing reference to FIG. 1, tour 12 begins at a starting address 38 in Reno, Nev., and terminates at an ending address 36 in Santa Monica, Calif. Tour 12 is presented in the form of a map that identifies each POI with a respective icon or maker 50. In other embodiments, tour 12 may comprise a listing of POIs without a map.

Web page 48 also presents a list 52 of POIs that correspond with markers 50 and the user is asked to identify which of the presented POIs that the user would like to visit. In some embodiments, web page 48 may also present a list of prepackaged routes that the user could select and integrate into their final tour. Each POI included in list 52 includes a selectable link. Each selectable link may lead to a separate website associated with that POI or to additional information about the POI stored on data storage device 16. By selecting the link, the user is enabled to make an informed decision regarding whether to include that POI in tour 12.

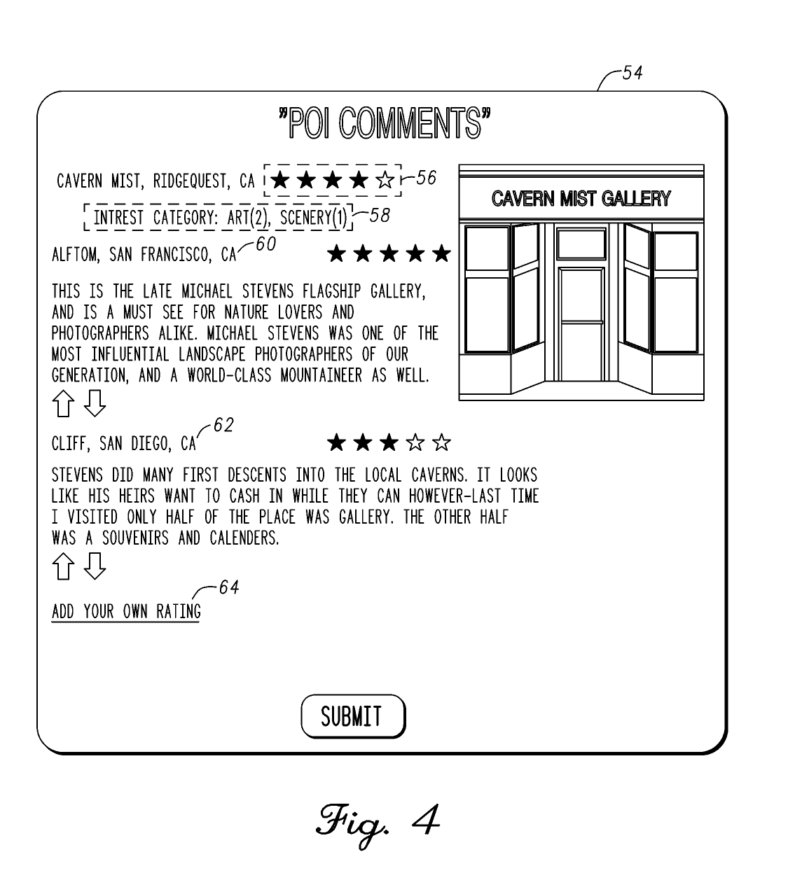

FIG. 4 illustrates an exemplary Internet web page 54 that provides a user with information about one of the POIs included in the tour produced by system 10 of FIG. 1. In this exemplary embodiment, and with continuing reference to FIG. 1, information about Cavern Mist in Ridgequest, Calif. is presented. One item of information presented is an overall rating 56 of four stars out of a possible five stars. This rating is provided by contributing users who have visited this POI.

Located below the name and the rating of the POI is an identification of interest categories 58 that Cavern Mist falls within. Accordingly, a user interested in art and scenery would enjoy this POI.

Positioned below interest categories 58 are two user reviews, first user review 60 and second user review 62. These user reviews were provided by contributing users who have each visited this particular POI and who subsequently visited website 18 to provide comments. In the illustrated embodiment, first and second user reviews 60 and 62 include a narrative and an individual rating supplied by each contributing user. If the user composing tour 12 chooses to include Cavern Mist on their tour, then when their vehicle approaches Cavern Mist, portable device 34 will trigger a playback of audio commentary and possibly video footage as well, depending upon the equipment available to the portable device. In some embodiments, the playback may optionally include some or all of the user reviews, although it is anticipated that such user reviews will primarily be used to aid the user in selecting which POIs to include in the tour. This can be accomplished through the use of a text to speech engine embedded in the user's vehicle or in portable device 34. In circumstances where there are numerous reviews supplied by contributing users, a user composing a tour may identify and select which of the user reviews are to be included in tour 12 and played back to the user during the tour. In other embodiments, the contributing user can upload audio commentary and video footage to website 18 for review by the user at the website and for playback to the user during the tour.

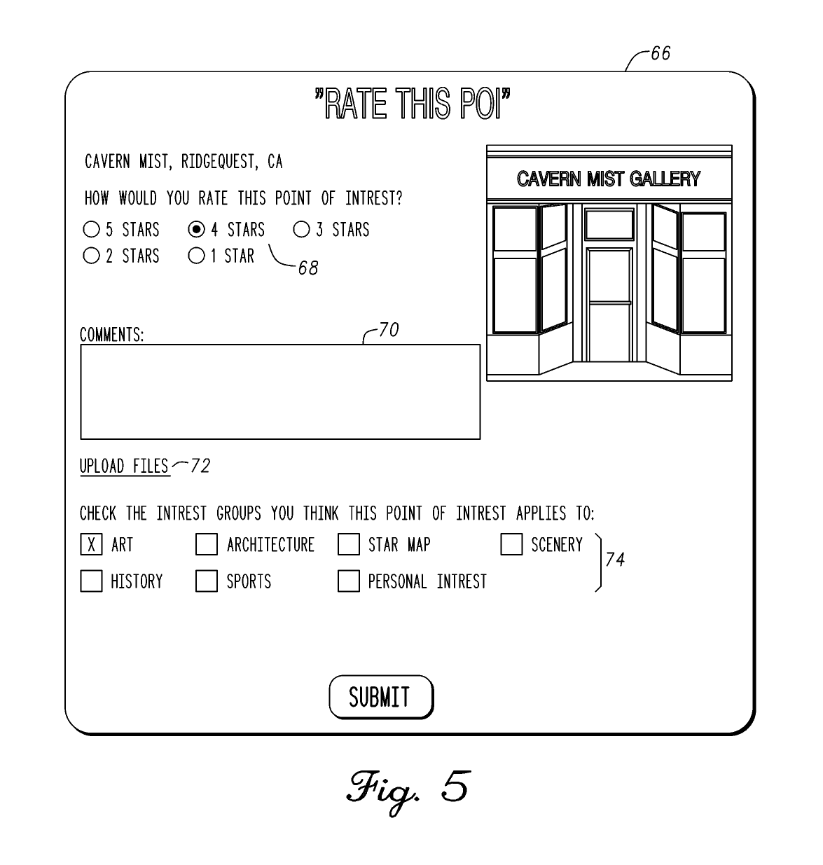

Beneath first and second user reviews 60 and 62, a rating link 64 is provided which allows a contributing user to add their own rating and review of the Cavern Mist POI. If a contributing user selects rating link 64, then website 18 will divert the contributing user to the web page illustrated in FIG. 5.

FIG. 5 illustrates an exemplary Internet web page 66 designed to permit a contributing user to provide feedback regarding a POI. With continuing reference to FIGS. 1 and 4, a contributing user selecting rating link 64 will be diverted to web page 66. At this web page, a contributing user can rate the POI by selecting a rating that corresponds with their assessment from a menu 68 of ratings. Located below menu 68 is a dialogue box 70 where the contributing user can add commentary relating to their experience at Cavern Mist.

Located below dialogue box 70 is an upload link 72. A contributing user selecting upload link 72 will be presented with a navigation box (not shown) that will permit the contributing user to navigate to a location on a hard drive or other computer peripheral device where photos, audio files, video files, image files, and other data is available. By selecting the appropriate files, the contributing user can upload such data to website 18 where it can then be viewed by other users.

Located below upload link 72 is category menu 74. Here, a contributing user may select one or more categories from a listing of predefined categories that apply to the POI being rated. In some embodiments, this categorization will be used by server 14 in filtering POIs from data storage device 16 for inclusion in subset 26. Note that uploading a POI maybe enabled on a website such as just described, or can be enabled by providing an application on a portable device such as a cell phone that collects the content (text, audio, and pictures) and uploads the content to the website from the device.

In some embodiments, server 14 may offer an Application Program Interface (API) that allows contributing users to automate the upload of information to server 14. This API may be in the form of an HTTP call with POI parameters. Such an API is useful for easily uploading a large number of POIs and pre-packaged tours that already exist on another server owned by the contributing user. Likewise, the API may also allow third-party applications to provide a new user interface into the tour generating features of this invention. Design and implementation of such APIs are commonly understood in the industry.

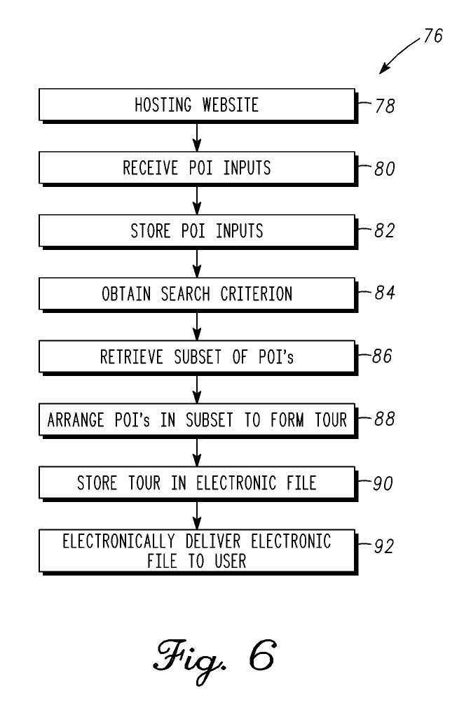

FIG. 6 is a flow diagram illustrating the steps of a method 76 for producing a tour. At block 78, a server is used to host an Internet accessible website. At block 80, the server received POI inputs from contributing users accessing the Internet accessible website. At block 82, the POI inputs are stored for future use in a data storage device that is operatively coupled to the server.

At block 84, POI search criterion is obtained from a user visiting the Internet website hosted on the server. The POI criterion is supplied by a user accessing the Internet accessible website for the purpose of composing a tour. At block 86, the server retrieves a subset of POI inputs and/or routes that correspond with the search criterion supplied by the user. At block 88, the server arranges the POI inputs and/or routes in the subset to form a tour.

At block 90, the server stores the tour in an electronic file. In some embodiments, such storage will be temporary. At block 92, the electronic file is electronically delivered to the user composing the tour. In some embodiments, the file will first be converted to a generic file format to facilitate use of the electronic file with a wide variety of portable devices. In other embodiments, the user may be presented with an option to select which of several file formats the electronic file may be downloaded in or converted to. Once the user has the electronic file, the user can download the tour to a portable device and then access the electronic file when the user takes the tour. In other embodiments, the user can download the electronic file directly to a portable device.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A system for producing a tour, the system comprising:
a data storage device configured to store a plurality of POI inputs and/or routes; and
a server operatively coupled to the data storage device and configured to:
host a website accessible via a worldwide computer network,
obtain a search criterion from a user accessing the website,
retrieve a subset of the POI inputs and/or routes corresponding to the search criterion from the data storage device,
arrange the POI inputs and/or routes of the subset in a manner corresponding to the search criterion to form the tour,
at least temporarily store the tour in an electronic file compatible with a mobile device, and
electronically deliver the electronic file to the user.

2. The system of claim 1, wherein the POI inputs include audio commentary.

3. The system of claim 1, wherein the electronic file includes a geographically synchronized command corresponding to at least one of the POI inputs in the subset.

4. The system of claim 1, wherein the search criterion includes a time restriction.

5. The system of claim 1, wherein the search criterion includes a range restriction.

6. The system of claim 1, wherein the search criterion includes a point of origin and a destination.

7. The system of claim 1, wherein the search criterion includes a user-interest restriction.

8. The system of claim 1, wherein the search criterion includes a user route preference.

9. The system of claim 1, wherein the server is further configured to permit the user to edit the tour.

10. A system for producing a tour, the system comprising:
a data storage device; and
a server operatively coupled to the data storage device and configured to:
host a website accessible via a worldwide computer network,
receive POI inputs and/or routes from a plurality of contributing users accessing the website,
provide the POI inputs and/or routes to the data storage device for storage,
obtain a search criterion from a user accessing the website,
retrieve a subset of the POI inputs and/or routes corresponding to the search criterion from the data storage device,
arrange the POI inputs and/or routes of the subset in a manner corresponding to the search criterion to form the tour,
at least temporarily store the tour in an electronic file compatible with a mobile device, and
electronically deliver the electronic file to the user.

11. The system of claim 10, wherein the server is further configured to receive a user rating of a POI and/or route.

12. The system of claim 11, wherein the search criterion includes a user-rating restriction.

13. The system of claim 10, wherein the server is further configured to:
receive predefined tours from the plurality of contributing users,
provide the predefined tours to the data storage device for storage,
retrieve one of the predefined tours corresponding to the search criterion from the data storage device,
at least temporarily store the one of the predefined tours in a second electronic file; and
download the second electronic file to the mobile device belonging to the user.

14. The system of claim 13, wherein the server is further configured to receive a user rating of the predefined tours and wherein the search criterion includes a user-rating restriction.

15. The system of claim 10, wherein the server is further configured to send an email to the user seeking user feedback on the tour.

16. The system of claim 10, wherein the POI inputs include audio commentary.

17. The system of claim 10, wherein the electronic file includes a geographically synchronized command corresponding to at least one of the POI inputs in the subset.

18. The system of claim 10, wherein the server is further configured to permit the user to edit the tour.

19. The system of claim 10, wherein the server is configured to provide the user with a user account and wherein the data storage device is configured to store information associated with the user account.

20. A method for producing a tour, the method comprising the steps of:
hosting a website accessible via a worldwide computer network;
receiving POI inputs and/or routes at a server from a plurality of contributing users accessing the website;
storing the POI inputs and/or routes in a data storage device;
obtaining search criteria at the server from a user accessing the website;
retrieving a subset of the POI inputs and/or routes corresponding to the search criteria from the data storage device,
arranging the POI inputs and/or routes in the subset in a manner corresponding to the search criteria to form the tour,
storing the tour in an electronic file compatible with a mobile device, and
electronically delivering the electronic file to the user.
